(19) United States
(12) Patent Application Publication
(10) Pub. No.: US 2023/0398623 A1
(43) Pub. Date: Dec. 14, 2023

(54) Electrode Clamping Device

(71) Applicant: Fronius International GmbH, Pettenbach (AT)

(72) Inventors: Klaus Oberndorfer, Pettenbach (AT); Helmut Wimroither, Pettenbach (AT); Anton Preundler, Pettenbach (AT)

(21) Appl. No.: 18/252,075

(22) PCT Filed: Nov. 12, 2021
(86) PCT No.: PCT/EP2021/081595

§ 371 Date: May 8, 2023

(30) Foreign Application Priority Data
Nov. 13, 2020 (EP) 20207582.6

(51) Int. Cl. B23K 9/29

(52) U.S. Cl. CPC B23K 9/296

(57) ABSTRACT

An electrode clamping device is provided for mechanically clamping a non-fusible, rod-shaped welding electrode in a welding torch. The electrode clamping device has a collet which is mounted into the welding torch from the rear into a collet housing of the electrode clamping device, which surrounds the collet. The collet is arranged so as to be movable along the longitudinal axis of the rod-shaped welding electrode relative to the collet housing, which surrounds it, in order to mechanically fixedly clamp and release the rod-shaped welding electrode.

### RELATED FILINGS

This application is a 35 U.S.C. § 371 National Stage Application of PCT/EP2021/081595, filed on Nov. 12, 2021, which claims the benefit of priority to Serial No. EP 20207582.6, filed on Nov. 13, 2020, in the EPO, the disclosures of which are incorporated herein by reference in their entirety.

### FIELD OF THE INVENTION

The invention relates to an electrode clamping device for mechanically clamping a non-fusible, rod-shaped welding electrode in a welding torch.

### BACKGROUND OF THE INVENTION

In the case of arc welding methods, it is possible to use non-fusible welding electrodes. These non-fusible welding electrodes include e.g. tungsten electrodes for TIG high-power welding. In the case of such arc welding methods, an arc burns between the non-fusible welding electrode and a workpiece. The arc and the welding zone are typically protected by a shield of inert gas or a gas mixture having active components. Conventional welding torches have a current contact element which fixes a welding electrode and has a clamping element for the non-fusible welding electrode. Furthermore, a conventional welding torch typically has a protective gas nozzle which surrounds the current contact element and the non-fusible welding electrode. Furthermore, a welding filler material can be supplied, from which material is transferred to the workpiece to be welded. During the welding process, the arc which forms between the welding electrode and the workpiece is powered by an energy source.

In the case of conventional welding torches, the non-fusible welding electrode is fixed, e.g. screwed in, by means of an electrode holder.

However, such a conventional welding electrode holder for a welding torch has the disadvantage that the non-fusible welding electrode either cannot be exchanged or serviced, such as e.g. ground, at all or can be so only with considerable technical outlay. Furthermore, the welding electrode fastened within the electrode holder cannot be easily displaced in the longitudinal direction. Consequently, it is also not easily possible to adjust how far the electrode tip of the welding electrode protrudes from the respective welding torch.

In addition, in the case of conventional electrode holders, material expansions which arise by reason of welding cycles during the welding process cannot be accommodated by the electrode holder and so the clamping force for holding the welding electrode is reduced over the course of time. As a result, the user or welder must then readjust the clamping force at certain time intervals when clamping the rod-shaped welding electrode. In addition, the material expansions which occur can result in damage to the clamping sleeve of the electrode holder.

### SUMMARY OF THE INVENTION

Therefore, it is an object of the present invention to provide an electrode clamping device for mechanically clamping a non-fusible, rod-shaped welding electrode in a welding torch, which avoids the aforementioned disadvantages and which, in particular, does not require any readjustment on account of material expansions.

Accordingly, the invention provides an electrode clamping device for mechanically clamping a non-fusible, rod-shaped welding electrode in a welding torch, wherein the electrode clamping device has a collet which is mounted into the welding torch from the rear into a collet housing of the electrode clamping device which surrounds the collet, wherein the collet is arranged so as to be movable along the longitudinal axis of the rod-shaped welding electrode relative to the collet housing, which surrounds it, in order to mechanically fixedly clamp and release the rod-shaped welding electrode.

The rod-shaped welding electrode is released in order either to remove the welding electrode or to insert a new welding electrode into the electrode clamping device or in order to change the position of the welding electrode in the welding torch or in order e.g. to grind the welding electrode.

In one possible embodiment of the electrode clamping device in accordance with the invention, the collet has, in the longitudinal direction, a front collet end with clamping jaws and a rear collet end. The collet housing has, in the longitudinal direction, a front collet housing end, e.g. with a clamping surface in the region of the front collet housing end for clamping the collet by means of the clamping surface in the collet housing, and a rear collet housing end for inserting the front collet end into and guiding it through the rear collet housing end. The collet can be guided through the collet housing and can be guided with its clamping jaws out of the front collet housing end thereof and can be clamped by means of the clamping surface of the clamping housing. The collet preferably has a current receiving contact surface for contacting and holding in a centred manner a welding electrode, in particular a rod-shaped welding electrode, which can be received in the collet. Preferably, the collet has, on its front collet end, an additional welding electrode receiving contour for receiving a rod-shaped welding electrode in the collet and in particular a blunt end of a rod-shaped welding electrode. In addition or alternatively, the collet housing which surrounds the collet preferably has at least one receiving contour, such that the collet can be pushed from the rear into and through the at least one receiving contour of the collet housing.

In one possible embodiment of the electrode clamping device in accordance with the invention, the collet has, at its front end portion, a plurality of clamping jaws which are arranged radially, are separated by means of slots and widen radially and/or axially.

In one possible embodiment of the electrode clamping device in accordance with the invention, the clamping jaws of the collet are pressed together by means of an internal clamping and current contact surface of the surrounding collet housing for holding in a centred manner the rod-shaped welding electrode introduced into the collet, as soon as the collet is moved to the rear relative to the collet housing, which surrounds it, in the welding torch.

In the case of a further possible embodiment of the electrode clamping device in accordance with the invention, the collet is moved relative to the collet housing, which surrounds it, by means of a spring mechanism of the electrode clamping device.

In a further possible embodiment of the electrode clamping device in accordance with the invention, the clamping jaws of the collet each have flat milled portions for optimising the clamping force. In addition, the current transfer can be improved thereby.

In a further possible embodiment of the electrode clamping device in accordance with the invention, the clamping jaws of the collet which are provided on the front end portion of the collet and widen radially and/or axially have a specified first opening angle.

In a further possible embodiment of the electrode clamping device in accordance with the invention, the collet housing has, on a front end portion, a contact-pressing surface having a second opening angle.

In a further possible embodiment of the electrode clamping device in accordance with the invention, the first opening angle of the collet is greater than or equal to the second opening angle of the surrounding collet housing.

In one possible embodiment of the electrode clamping device in accordance with the invention, the first opening angle of the collet is in an angle range of 20 to 120°, in particular in an angle range of 35° to 75°, and is preferably 70°.

In a further possible embodiment of the electrode clamping device in accordance with the invention, the second opening angle of the collet housing is in an angle range of 0 to 120°, in particular in an angle range of 0° to 80°, and is preferably °.

In a further possible embodiment of the electrode clamping device in accordance with the invention, the collet which is arranged so as to be movable along the longitudinal axis of the rod-shaped welding electrode is connected to a pressure cap which is provided on a rear side of the welding torch, can be manually actuated and surrounds the spring mechanism of the electrode clamping device.

In a further possible embodiment of the electrode clamping device in accordance with the invention, the collet housing has radial bores, through which a protective gas supplied to the welding torch is discharged into a gas nozzle surrounding the welding electrode.

In a further possible embodiment of the electrode clamping device in accordance with the invention, the contact-pressing surface provided on the front end portion of the collet housing has a radius which is in a range of 0 to 1 mm and is preferably mm.

In a further possible embodiment of the electrode clamping device in accordance with the invention, the surface of the collet and/or of the collet housing is surrounded by a current-conducting oxidation protective layer for protecting against oxidation and/or for protecting against wear during usage, in particular during displacement of the collet with respect to the collet housing.

In one possible embodiment of the electrode clamping device in accordance with the invention, the current-conducting oxidation protective layer consists of silver or nickel or has a high-temperature sliding lacquer coating.

In a further possible embodiment of the electrode clamping device in accordance with the invention, the material of the collet consists of a copper alloy.

In a further possible embodiment of the electrode clamping device in accordance with the invention, auxiliary components, in particular a cold wire or hot wire supplying unit, can be mounted on a housing of the welding torch.

In a further possible embodiment of the electrode clamping device in accordance with the invention, a first current contact surface between the rod-shaped welding electrode and the collet and a second current contact surface between the collet and the collet housing are arranged axially offset with respect to one another.

In a further possible embodiment of the electrode clamping device in accordance with the invention, the slots of the collet have a slot length of 10 to 20 mm, preferably 14 mm.

### BRIEF DESCRIPTION OF THE DRAWINGS

Possible embodiments of the electrode clamping device in accordance with the invention will be explained in greater detail hereinafter with reference to the attached figures.

In the drawings:

FIG. 1 shows a sectional view through one possible embodiment of the welding torch comprising an electrode clamping device in accordance with the invention;

FIG. 2 shows a view to explain the mounting of an electrode clamping device in accordance with the invention into a welding torch;

FIG. 3 shows a view of one possible exemplified embodiment of a collet of an electrode clamping device in accordance with the invention;

FIGS. 4A, 4B show sectional views to explain possible embodiment variants of an electrode clamping device in accordance with the invention;

FIG. 4C shows an enlarged detail of the embodiment variant of an electrode clamping device in accordance with the invention shown in FIG. 4A;

FIG. 5 shows a front view of an electrode clamping device in accordance with the invention having a clamped, non-fusible welding electrode;

FIG. 6A shows a sectional view of the embodiment variant of the electrode clamping device in accordance with the invention shown in FIGS. 4A and 4C, wherein the collet is moved with its front collet end in the direction of the front collet housing end;

FIG. 6B shows a sectional view of the electrode clamping device shown in FIG. 6A, wherein the collet with its front collet end has reached the smallest inner diameter of the collet housing;

FIG. 6C shows a sectional view of the electrode clamping device shown in FIGS. 6A and 6B, wherein the collet has passed with its front collet end through the smallest inner diameter of the collet housing and is located in a clamping position;

FIG. 6D shows the sectional view of the electrode clamping device shown in FIG. 6C, wherein a rod-shaped welding electrode is illustrated clamped in the collet in the clamping position thereof; and

FIG. 7 shows a detail of a further exemplified embodiment of the welding torch 1 in a sectional view.

### DETAILED DESCRIPTION OF EMBODIMENTS

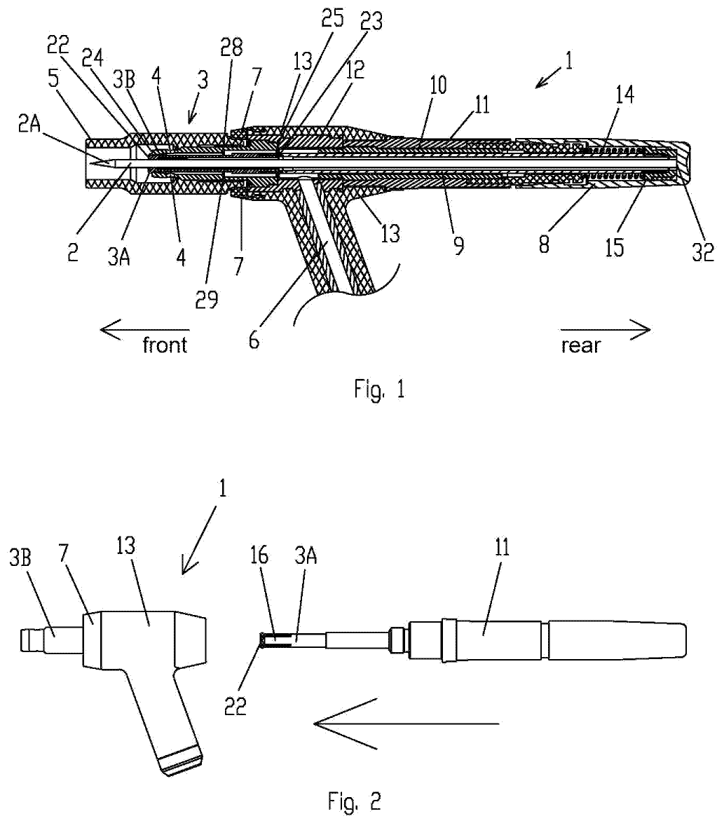

FIG. 1 shows a sectional view of an exemplified embodiment of an electrode clamping device 3 in accordance with the invention for mechanically clamping a non-fusible, rod-shaped welding electrode 2 into a welding torch 1. FIGS. 4A, 4B show further sectional views to illustrate preferred embodiments of the electrode clamping device 3 in accordance with the invention.

FIG. 1 shows a welding torch 1 having an electrode clamping device 3 in accordance with the invention for mechanically clamping a non-fusible, rod-shaped welding electrode 2 into the welding torch 1. A tip 2A of the rod-shaped welding electrode 2 can be seen in FIG. 1 on the front left side of the welding torch 1. The electrode clamping device 3 has a collet 3A which is mounted into the welding torch 1 from the rear, i.e. from the right in FIG. 1, into a collet housing 3B of the electrode clamping device 3, which surrounds the collet 3A.

The collet 3A has a front collet end 22 with a front end portion with clamping jaws 16 and a rear collet end 23. Furthermore, the collet housing 3B has a front collet housing end 24 and a rear collet housing end 25.

As shown in FIG. 1, the collet 3A can be pushed or moved with its front collet end 22 and the clamping jaws 16 from the rear into the rear collet housing end 25 of the collet housing 3B. The collet 3A can be pushed out or moved with its front collet end 22 and its clamping jaws 16 through the front collet housing end 24.

There are two possible approaches which lead to the result that the collet 3A is mounted from the rear into collet housing 3B.

In the case of the first approach, the collet housing 3B is located in the welding torch and the collet 3A is then inserted. The collet 3A is pushed or moved with its front collet end 22 and the clamping jaws 16 from the rear into the rear collet housing end 25 of the collet housing 3B.

In the case of the second approach, the collet 3A is located in the welding torch and the collet housing 3B is inserted and screwed on from the front. The collet housing 3B is pushed or moved with its rear collet housing end 25 onto the front collet end 22 of the collet 3A and therefore the collet 3A is inserted or moved with its front collet end 22 into the rear collet housing end 25. The collet 3A is arranged so as to be movable along the longitudinal axis of the rod-shaped welding electrode 2 relative to the collet housing 3B, which surrounds it, in order to mechanically fixedly clamp or release the rod-shaped welding electrode 2. As can be seen in FIG. 1, the collet housing 3B has radial bores 4, through which a protective gas supplied to the welding torch 1 is discharged into a gas nozzle 5 surrounding the welding electrode 2. The protective gas is supplied to the welding torch 1 via a hose assembly via supply lines 6. The welding torch 1 has an isolating ring 7 for electrically and thermally isolating the welding torch 1. As illustrated in FIG. 1, the collet 3A which is arranged so as to be movable along the longitudinal axis of the rod-shaped welding electrode 2 is connected to a pressure cap 8 which is provided on a rear side of the welding torch 1 and can be actuated manually. In the embodiment illustrated in FIG. 1, the pressure cap 8 surrounds a spring mechanism for moving the collet 3A relative to the collet housing 3B which surrounds it. The welding electrode 2 is located in an inner cylinder 9 of the welding torch 1 which surrounds the welding electrode 2, as illustrated in the sectional view shown in FIG. 1. Furthermore, the welding torch 1 has an outer cylinder 10 which is surrounded by a casing 11. Furthermore, the welding torch 1 has a receiving housing 12 which is embedded into a rubber casing 13. In the case of the exemplified embodiment illustrated in FIG. 1, the spring mechanism has a compression spring 14 which lies on a rear side against a spring stop 15. The pressure cap 8 surrounds the spring 14 and the spring stop 15. During assembly, the collet 3A can be pushed from the rear through a clamping contour, as also illustrated in FIG. 2. This avoids awkward screwing of the welding electrode 2 into the welding torch 1 from the front.

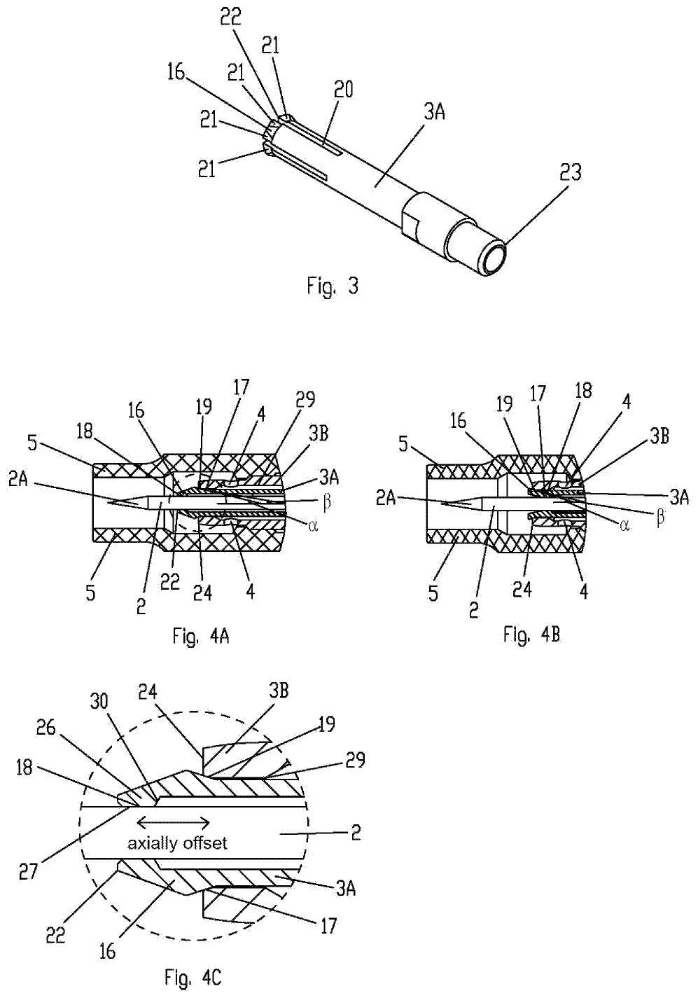

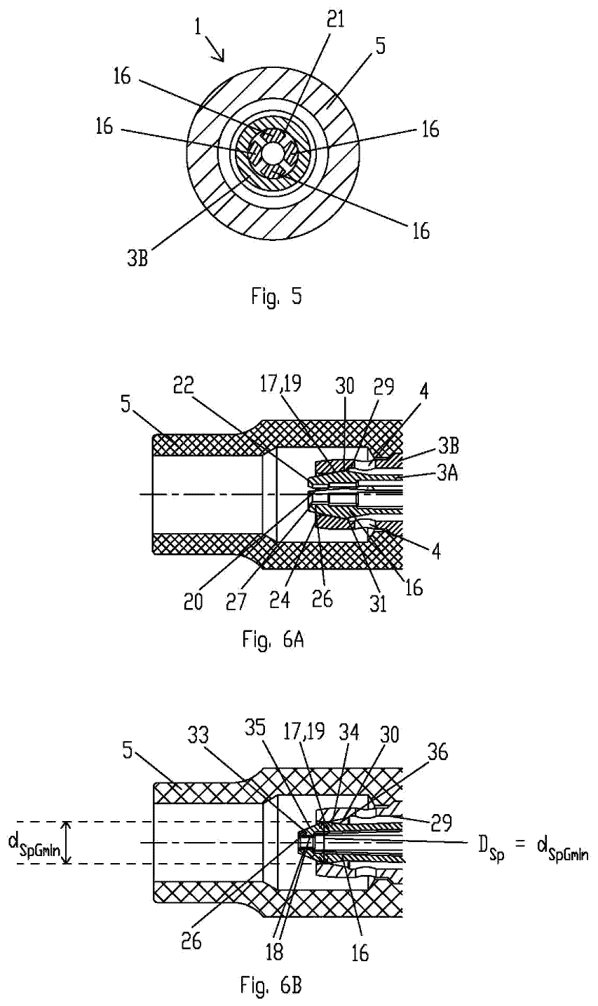

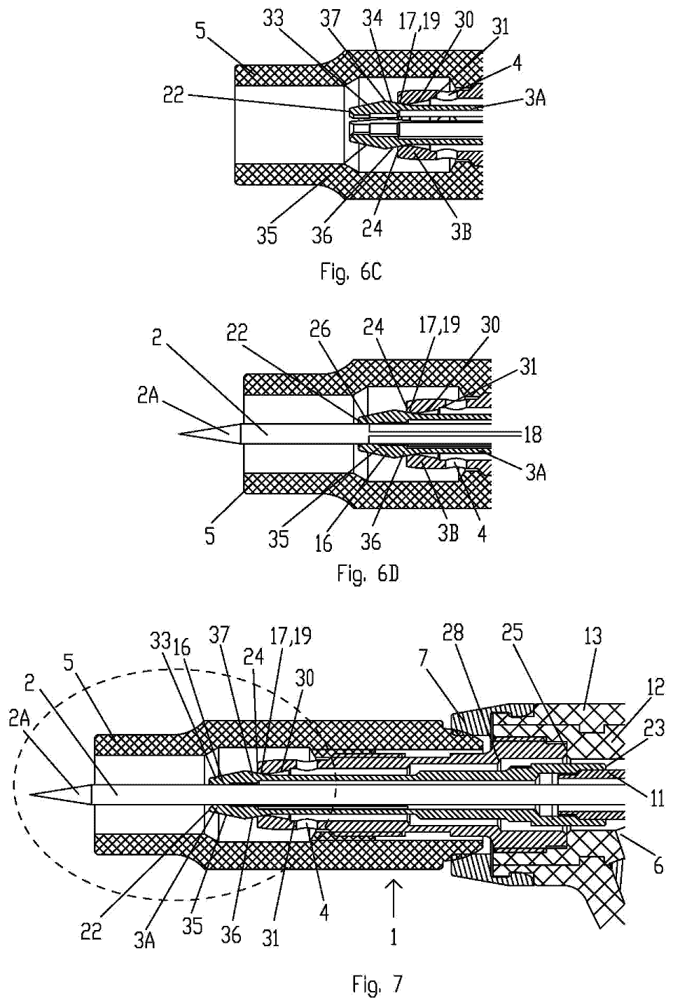

FIGS. 4A, 4B, 4C and subsequent FIGS. 6A, 6B, 6C and 6D show detailed views of the front portion of the welding torch 1. FIGS. 4A, 4B show two alternative embodiments of the electrode clamping device 3 in accordance with the invention, wherein FIG. 4C shows an enlarged detail of the embodiment variant of the electrode clamping device in accordance with the invention shown in FIG. 4A. The embodiments of the collet 3A, as shown in FIGS. 3, 4A, 4B, 4C and 6A-D, can be inserted into the welding torch 1. FIGS. 4A, 4B, 4C show the collet 3A which is surrounded by the collet housing 3B. As can be seen in FIGS. 4A, 4B, 4C and subsequent FIGS. 6A-6D, the collet 3A has, at its front end portion, a plurality of clamping jaws 16 separated by slots 20. They are pressed together by means of an inner clamping surface 17 of the surrounding collet housing 3B in order to hold in a centred manner the rod-shaped welding electrode 2 which is introduced into the collet 3A, as soon as the collet 3A is moved to the rear relative to the collet housing 3B, which surrounds it, in the welding torch 1.

FIGS. 4A, 4B, 4C and subsequent FIG. 6D show the welding electrode 2 in the clamped state, i.e. in a state in which the clamping jaws 16 of the collet 3A are pressed together by means of the clamping and current contact surfaces of the surrounding collet housing 3B. By manually actuating the pressure cap 8 which is provided on the welding torch 1 at the rear and surrounds the compression spring 14, the collet 3A can be urged forwards relative to the collet housing 3B engaging around it, such that the clamping force exerted by the clamping contact surface 17 is reduced by reason of the shape of the clamping jaws 16. As a result, the holding force for holding the welding electrode 2 in a centred manner is reduced to such an extent that the welding electrode 2 can be easily guided out of the welding torch 1 from the front, as long as the pressure cap 8 remains pressed. In this manner, it is possible either to replace a welding electrode 2 with a new welding electrode or to adjust the extent to which the tip 2A of the welding electrode 2 protrudes from the welding torch 1. In one possible embodiment, the material of the collet 3A can consist of a copper alloy, in particular a hard copper alloy. In addition, the surface of the collet 3A and/or of the collet housing 3B can be surrounded by a current-conducting oxidation protective layer for protecting against oxidation. In one possible embodiment, this current-conducting oxidation protective layer consists of silver or nickel. Furthermore, the current-conducting oxidation protective layer can also have a high-temperature sliding lacquer coating. Provided between the rod-shaped welding electrode 2 and the collet 3A is a first current contact surface 18, as illustrated in FIGS. 4A, 4B, 4C and subsequent FIGS. 6A-6D. The mechanical clamping surface 17 which is provided for fixedly clamping the collet 3A by means of the surrounding collet housing 3B forms a second current contact surface 19. As can be seen in FIGS. 4A, 4B, 4C and subsequent FIGS. 6A-6D, the first current contact surface 18 between the rod-shaped welding electrode 2 and the collet 3A and the second current contact surface 19 between the collet 3A and the collet housing 3B are arranged axially offset with respect to one another along the longitudinal axis. This prevents the collet 3A from becoming adhered undesirably to the collet housing 3B in the event of high electric currents. This is required particularly in the case of high welding powers. Moreover, an additional mechanical spring effect is achieved by means of the offset arrangement of the current contact surfaces 18, 19. In this manner, thermal expansions of the components which occur to a greater extent particularly in the event of high welding powers can be accommodated or compensated for. The collet 3A and the surrounding collet housing 3B preferably lie closely one on top of the other, wherein the collet housing 3B has a radius in the contact region. This prevents to a certain extent any pressing of the collet housing 3B into the surrounded collet 3A, particularly in the event of high current outputs or in the event of a large number of actuating procedures for clamping, releasing or installing the welding electrode 2.

The spring mechanism can alternatively also be actuated by means of a controlled actuator.

FIG. 2 shows the assembly of a welding torch 1. As can be seen in FIG. 2, the collet 3A is pushed from the rear through a receiving contour of the surrounding collet housing 3B. As a result, awkward screwing from the front can be omitted. This results in easier handling.

FIG. 3 shows an exemplified embodiment of collet 3A of the electrode clamping device 3 in accordance with the invention. The collet 3A has the front collet end 22 with the front end portion with the clamping jaws 16, which can be guided or moved into the rear collet housing end 25 of the collet housing 3B. The collet 3A has, at its front end portion, i.e. facing forwards in the installed state, a plurality of clamping jaws 16 which are arranged radially and separated from one another by means of slots 20. In the case of the exemplified embodiment illustrated in FIG. 3, these widen radially outwards at the front. In the installed state, the collet 3A illustrated in FIG. 3 is arranged so as to be movable relative to the collet housing 3B surrounding it. In one possible implementation, the slots 20 of the collet 3A have a slot length of 10 to 20 mm, preferably 14 mm. In the embodiment illustrated in FIG. 3, the clamping jaws 16 also have flat milled portions 21 for optimising the clamping force. These flat milled portions 21 can also be seen in the front view shown in FIG. 5. As can be seen in FIG. 5, the welding electrode 2 is held in a centred manner e.g. by means of four uniformly spaced-apart clamping jaws 16 of the collet 3A. The number of clamping jaws 16 can vary. The collet housing 3B surrounds the clamping jaws 16 and presses them against the cylindrical surface of the welding electrode 2, as can be seen in FIG. 5. The clamping jaws 16 have flat milled portions 21, as illustrated in FIG. 5. By reason of the flat milled portions 21, the clamping force which is exerted upon the clamping jaws 16 can be increased. Clamping jaws 16 which widen radially are provided on a front end portion of the collet 3A. These clamping jaws 16 have a first opening angle α, as illustrated in FIGS. 4A, 4B, 4C and subsequent FIGS. 6A-6D. The collet housing 3B has, at a front end portion, a contact-pressing surface 17 with a second opening angle β, as illustrated in FIGS. 4A, 4B, 4C and subsequent FIGS. 6A-6D. The first opening angle α of the collet 3A is larger than the second opening angle β, of the surrounding collet housing 3B. In one possible embodiment, the first opening angle α of the widening clamping jaws 16 is in an angle range of 20 to 50°. In one possible embodiment, the first opening angle α is 35°. The second opening angle β, of the contact-pressing surface 17 at the front end portion of the collet housing 3B is preferably in an angle range of 0 to 50°. In one possible embodiment, the second opening angle β, is 30°. Moreover, in one possible embodiment the contact-pressing surface 17 provided on the front end portion of the collet housing 3B has a radius which can be e.g. in a range of 0 to 1 mm and is preferably 0.1 mm.

In one possible embodiment, further auxiliary components can be mounted on the housing casing 11 of the welding torch 1 illustrated in FIG. 1. Said components include e.g. a cold wire or hot wire supplying unit. The TIG electrode clamping system illustrated in FIG. 1 clamps the welding electrode 2 with an integrated compression spring 14 with the aid of a collet 3A and a collet housing 3B surrounding it. By reason of the particular geometry of the collet 3A and the surrounding collet housing 3B, it is possible to maximise the clamping force and at the same time compensate for possible material expansions which occur during the welding process, such that no readjustment has to be performed. The particular arrangement of the current contact surfaces 18, 19, in particular their axial offset with respect to one another along the longitudinal axis also renders it possible to perform the welding process with high current amplitudes, without the collet 3A becoming adhered undesirably to the collet housing 3B. The particular arrangement of the current contact surfaces 18, 19 ensures a stable and constant current transfer. This also serves to stabilise the arc produced during the welding process. Even in the case of high current intensities, the collet 3A and the collet housing 3B do not weld together, thereby ensuring reliable clamping and releasing of the welding electrode 2. The electrode clamping system and the electrode clamping device 3 in accordance with the invention also provide space for attaching auxiliary components to the housing casing 11 of the welding torch 1. The relative position of the current contact surfaces 18, 19 can be different. In the case of the exemplified embodiment illustrated in FIGS. 4A, 4C and 6A-6D, the annular first current contact surface 18 which is segmented by means of slots is located in front of the likewise annular, segmented second current contact surface 19, i.e. the first current contact surface 18 is located more closely to the tip 2A of the welding electrode 2. In the case of the exemplified embodiment illustrated in FIG. 4B, the opposite applies, i.e. in this case the second annular, segmented current contact surface 19 is located more closely to the tip 2A of the welding electrode 2 in the longitudinal direction. In the two exemplified embodiments, the axial offset of the current contact surfaces 18, 19 can be in the range of 0.5 mm to 15 mm, preferably 3 mm to 4 mm.

FIGS. 6A, 6B, 6C and 6D show detailed views of the front portion of the welding torch 1, e.g. a welding torch 1 as previously shown and described in FIG. 1 and FIG. 2, and of the collet housing 3B received therein, and of the collet 3A of the embodiment variant of the electrode clamping device in accordance with the invention shown in FIGS. 4A to 4C. More specifically, FIGS. 6A-6D show various positions of the collet 3A relative to the collet housing 3B. The collet 3A and its clamping jaws 16 are moved through the collet housing 3B in the direction of the front collet housing end 22 and out of the collet housing 3B, as shown in FIGS. 6A-6D, until the collet 3A, as in FIGS. 6C and 6D, has reached a clamping position or a clamping state, in which it can hold a welding electrode 2 in a centred manner. FIG. 6D corresponds to the mounted welding electrode 2 with respect to FIGS. 4A and 4C.

FIGS. 6A and 6B show the movement of the collet 3A with its clamping jaws 16 forwards and through the region of the collet housing 3B with its clamping or contact-pressing surface 17, wherein the collet 3A, with its slots 20, is compressed by means of the collet housing 3B.

FIGS. 6C and 6D show the collet 3A in the clamping position or the clamping state, in which the clamping jaws 16 of the collet 3A are pressed together by the clamping or contact-pressing surface 17 and the second current contact surface 19 of the surrounding collet housing 3B. The collet 3A contacts, by means of its first current contact surface 18, a rod-shaped welding electrode 2 received in the collet 3A and holds it in a centred manner, as shown in FIG. 6D. The rod-shaped welding electrode 2 has the tip 2A at a front end and has a blunt end (32) at the rear end.

In the clamping position or clamping state, the collet 3A, with the welding electrode 2 received, as shown in FIG. 6D, is no longer able to be moved undesirably back in the direction of the rear collet housing end 25. However, when the welding torch 1 is mounted as previously shown in FIG. 1, said collet can be moved further forwards by actuating, in this case e.g. pressing, the pressure cap 8 in FIG. 1. By actuating the pressure cap 8 shown in FIG. 1, the collet 3A in FIG. 6D can be urged forwards relative to the collet housing 3B engaging around it, such that the clamping force exerted by the clamping or contact-pressing surface 17 is reduced by reason of the shape of the clamping jaws 16. As a result, the holding force for holding the welding electrode 2 in a centred manner is reduced to such an extent that the welding electrode 2 can be easily guided out of the welding torch 1 from the front, as long as the pressure cap 8 remains actuated, in this case e.g. pressed. As a result, e.g. a welding electrode 2 can be replaced by a new welding electrode or the protruding of the tip 2A of the welding electrode 2 from the welding torch 1 can be adjusted.

As previously described with reference to FIGS. 4A and 4C, the collet 3A has, at its front collet end 22 and more precisely its front end portion, the plurality of clamping jaws 16 which are separated by slots 20.

The first current contact surface 18 is provided between the rod-shaped welding electrode 2 and the collet 3A in FIG. 6D and previously in FIGS. 4A and 4C. More precisely, the collet 3A and in particular its clamping jaws 16 segmented by the slots have on their inner side a protrusion 26 which provides the current contact surface 18 of the collet 3A with a rod-shaped welding electrode 2 mounted in the collet 3A. At the front collet end 22, the collet 3A is additionally chamfered preferably inwards as far as the current contact surface 18 in order to provide a welding electrode receiving contour 27, and in particular a welding electrode receiving contour which tapers conically or funnel-like inwards in the direction of the rear collet end 23. The welding electrode receiving contour 27 which is chamfered inwards or tapers conically or funnel-like inwards makes it easier to thread the rod-shaped welding electrode 2 into the front collet end 22 of the collet 3A.

The collet housing 3B has the same or substantially the same structure as the collet housing 3A in FIG. 1, and so in this respect reference is made to the description relating to FIG. 1 in order to avoid unnecessary repetition. As previously with the collet housing 3A in FIG. 1, the collet housing 3B likewise has preferably at least one first receiving contour or a first collet receiving contour 28 which makes it easier to thread the collet 3A within collet housing 3B. The collet housing 3B has, like the collet housing 3A previously in FIG. 1, a through-opening 29, in particular a stepped through-bore, in the longitudinal direction, of which the diameter decreases, in particular in a stepwise manner, from the rear collet housing end 25 to the front collet housing end 24. At least one, several or all of these steps or gradations in the collet housing 3B can be additionally chamfered or can taper funnel-like or conically in the direction of the front collet housing end 24 in order thus to make it easier to thread in and guide the collet 3A through the collet housing 3B, and thus provide a respective collet receiving contour 28, 30, 31. As previously shown in FIG. 1, the through-opening 29, in particular the stepped through-bore, has a first receiving contour or first collet receiving contour 28 and at least one second receiving contour or second collet receiving contour 30. The second receiving contour 30 tapers towards the current contact surface 18, as shown in FIGS. 6A-6D. A third receiving contour 31 can optionally be provided in front of it. The respective first, second and third collet receiving contour 28, 30, 31 are chamfered or taper funnel-like or conically in the direction of the front collet housing end 24 in the collet housing 3B and its through-opening 29, in particular its through-bore. As a result, the movement of the collet 3A through the through-opening 29 of the collet housing 3B can be made easier and the collet 3A in the stepped through-opening 29 can be threaded through more easily from the rear collet housing end 25 to the front collet housing end 24.

The through-opening 29 has, in the region of the rear collet housing end 25, the largest inner diameter d_{SpGmax} and has, in the region of the clamping or contact-pressing surface 17, the smallest inner diameter d_{SpGrain}, as shown in FIGS. 1, 4A-4C and 6A-6D.

As described above, in addition to forming the first current contact surface 18 of the collet 3A, the mechanical clamping or contact-pressing surface 17 of the collet housing 3B, which is provided for fixedly clamping the collet 3A by means of the surrounding collet housing 3B, forms the second current contact surface 19. As can be seen previously in FIGS. 4A and 4C and subsequent FIGS. 6C and 6D, the first current contact surface 18 between the rod-shaped welding electrode 2 and the collet 3A and the second current contact surface 19 between the collet 3A and the collet housing 3B are arranged axially offset with respect to one another along the longitudinal axis or in the longitudinal direction.

In the case of the exemplified embodiment illustrated in FIGS. 4A, 4C and 6A-6D, the annular first current contact surface 18 segmented by the slots 20 is located in front of the likewise annular second current contact surface 19 segmented by the slots 20. In other words, the first current contact surface 18 is located in the axial direction more closely to the tip 2A of the welding electrode 2 than the second current contact surface 19.

The clamping jaws 16 of the collet 3A have the first opening angle α, as illustrated previously in FIGS. 4A and 4C and FIGS. 6A-6D. The collet housing 3B has, again at the front end portion, the clamping or contact-pressing surface 17 with the second opening angle β, as illustrated previously in FIGS. 4A, 4C and then in FIGS. 6A-6D.

In addition, in one possible embodiment, including that already shown in FIGS. 6A-6D, the clamping or contact-pressing surface 17 provided on the front end portion of the collet housing 3B can have a radius. This radius can be e.g. in a range of 0 to 1 mm and can preferably be 0.1 mm.

In a further possible embodiment, e.g. the one in FIGS. 6A-6D, the first opening angle α and the second opening angle β can also be the same size instead of being different, wherein the first and second opening angles α and β can each be in a range of preferably 20° to 50°. In a particularly preferred manner, the first opening angle α and the second opening angle β, are each 20°.

In the embodiment shown previously in FIGS. 4A and 4C and then in FIGS. 6A-6D, the clamping jaws 16 segmented by the slots 20 have a front clamping jaws portion 33 and a rear clamping jaws portion 34.

The front clamping jaws portion 33 can be formed as a front conical portion 35 which is segmented by the slots 20 and tapers conically or funnel-like towards the front collet end 22. The rear clamping jaws portion 34 forms a rear conical portion 36 which is segmented by the slots 20 and has the first opening angle α of e.g. 20°. The rear conical portion 36 tapers in the direction of the rear collet end 23. Corresponding to this, the collet housing 3B has, on the front end portion, the corresponding clamping contact or contact-pressing surface 17 having the second opening angle β, which is preferably the same size as the first opening angle α, e.g. 20°.

The front conical portion 35 of the clamping jaws 16 in the exemplified embodiment in FIGS. 6A-6D and previously in FIGS. 4A and 4C has the advantage that the collet 3A can be threaded more easily through the collet housing 3B and in particular its region having the clamping or contact-pressing surface 17 which has the smallest inner diameter d_{SpGmin}.

At the transition, in this case e.g. in the form of a tip 37 or plateau (not illustrated), between the front conical portion 35 and the rear conical portion 36, the exit outer diameter D_{SPmax} of the clamping jaws 16 of the collet 3A is at its largest. The exit outer diameter D_{SPmax} of the clamping jaws 16 of the collet 3A is e.g. in a range of 4.8 mm to 5.8 mm. Therefore, in order for the collet 3A with its clamping jaws 16 to be guided through the region of the collet housing 3B with the smallest diameter d_{SpGmin}, as shown in FIGS. 6A and 6B, said collet and clamping jaws must be sufficiently pressed together and more precisely to this smallest diameter d_{SpGmin}. The smallest diameter d_{SpGmin} in the region of the clamping or contact-pressing surface 17 of the collet housing 3B is e.g. in a range of 4 mm to 5 mm. Accordingly, the collet 3A and more precisely its clamping jaws 16 segmented by the slots 20 must be designed such that the clamping jaws 16 with their largest exit outer diameter D_{SPmax} of e.g. 4.8 to 5.8 mm, must be able to be pressed together or compressed correspondingly to the size of the corresponding smallest diameter d_{SpGmin} of the collet housing 3B.

When the collet 3A is mounted in the collet housing 3B, the clamping jaws 16 are clamped by the mechanical clamping or contact-pressing surface 17 of the collet housing 3B, as shown in FIGS. 6C and 6D.

For example, the collet 3A, as shown previously in figure can have four clamping jaws 16 and four slots 20 accordingly. In order to suitably press together the clamping jaws 16 segmented by the slots 20, it is possible to select e.g. a suitable slot width for the slots.

In the case of a largest or maximum exit outer diameter D_{SPmax} of the clamping jaws 16, e.g. in a range of 4.8 mm to 5.8 mm, and in the case of e.g. three or, as shown in FIG. 5, four clamping jaws 16, the slot width SB of the slots 20 e.g. between the clamping jaws 16 can be in a range of 0.5 mm to 1 mm and preferably in a range of 0.6 to 0.8 mm in order to press the clamping jaws 16 suitably together.

The electrode clamping device 3 thus provides a collet 3A which has, in the longitudinal direction, a front collet end 22 with clamping jaws 16 and a rear collet end 23 (as shown e.g. in FIGS. 1, 2, 3, 4a-4C, 5, 6A-6D and 7), and wherein the collet housing 3B has, in the longitudinal direction, a front collet housing end 24, in particular for clamping the collet 3A by means of a clamping surface 17 in the collet housing 3B, and a rear collet housing end 25 for guiding the front collet end 22 into and through the rear collet housing end 25 (as shown e.g. in FIGS. 1, 2, 3, 4A-4C, 5, 6A-6D and 7), and wherein the collet 3A can be guided through the collet housing 3B and can be guided with its clamping jaws 16 out of the front collet housing end 22 thereof and can be clamped by means of the clamping surface 17 of the collet housing 3B (as shown e.g. in FIGS. 1, 2, 3 4A-4C, 5, 6A-6D and 7), wherein the collet 3A preferably has a current receiving contact surface 18, in particular for contacting and for holding in a centred manner a welding electrode, in particular a rod-shaped welding electrode 2, which can be received in the collet 3A, and wherein the collet 3A has, at its front collet end 22, preferably an additional welding electrode receiving contour 27 (as shown in FIGS. 4A, 4C, 6A-6D and subsequent figure FIG. 7) for receiving a rod-shaped welding electrode 2 in the collet 3A and in particular a blunt end of a rod-shaped welding electrode 2.

FIG. 7 shows a detail of an exemplified embodiment of the welding torch 1 which differs from the welding torch 1 in FIG. 1 essentially by reason of the inserted collet 3A and the collet housing 3B.

The region or part of the collet 3A and the collet housing 3B which is surrounded by a dashed circle corresponds to the collet 3A and the collet housing 3B, as shown and described in FIGS. 4A, 4C and in particular FIGS. 6A-6D. Therefore, like reference signs are used and reference is made in this respect to the description and to FIGS. 4A, 4C and FIGS. 6A-6D in order to avoid unnecessary repetition. The first and second opening angles α and β are not indicated in FIG. 7 for reasons of clarity.

The collet housing 3B in FIG. 7 has, like the collet housing 3B previously in FIG. 1, a through-opening 29, in particular a stepped through-bore, in the longitudinal direction, of which the diameter decreases, in particular in a stepwise manner, from the rear collet housing end 25 to the front collet housing end 24. At least one, several or all of these steps or gradations in the collet housing 3B can be additionally chamfered or can taper funnel-like or conically in the direction of the front collet housing end 24 in order thus to provide collet receiving contours which make it easier to thread in and guide the collet 3A through the collet housing 3B.

Furthermore, the welding torch 1, as shown in FIG. 7, has, as previously with the welding torch in FIG. 1, the supply line 6, the isolating ring 7, the inner cylinder 9, the welding torch housing 12 and the rubber casing 13 etc. The part of the welding torch 1 with the outer cylinder, the compression spring, the compression spring stop is not illustrated in the detail in FIG. 7 in contrast to FIG. 1.

### LIST OF REFERENCE SIGNS

1 welding torch
2 welding electrode
2A tip of the rod-shaped welding electrode
3 electrode clamping device
3A collet
3B collet housing
4 radial bores
5 protective gas nozzle
6 supply lines
7 isolating ring
8 pressure cap
9 inner cylinder
10 outer cylinder
11 housing casing
12 welding torch housing
13 rubber casing
14 compression spring
15 compression spring stop
16 clamping jaws
17 contact-pressing surface
18 first current contact surface
19 second current contact surface
20 slots
21 flat milled portions
22 front collet end
23 rear collet end
24 front collet housing end
25 rear collet housing end
26 protrusion
27 welding electrode receiving contour
28 first collet receiving contour
29 through-opening (through-bore)
30 second collet receiving contour
31 third collet receiving contour
32 blunt end of the welding electrode
33 front clamping jaws portion
34 rear clamping jaws portion
35 front conical portion
36 rear conical portion
37 tip

1. An electrode clamping device for mechanically clamping a non-fusible, rod-shaped welding electrode in a welding torch, wherein the electrode clamping device has a collet which is mounted into the welding torch from the rear into a collet housing of the electrode clamping device, which surrounds the collet, wherein the collet is arranged so as to be movable along the longitudinal axis of the rod-shaped welding electrode relative to the collet housing, which surrounds it, in order to mechanically fixedly clamp and release the rod-shaped welding electrode.

2. The electrode clamping device as claimed in claim 1,
wherein the collet has, in the longitudinal direction, a front collet end with clamping jaws and a rear collet end, and
wherein the collet housing has, in the longitudinal direction, a front collet housing end and a rear collect housing end for inserting the front collet end into and guiding it through the rear collect housing end, and
wherein the collet can be guided with its front collet end into the rear collet housing end, wherein the collet has, at its front collet end, an additional welding electrode receiving contour for receiving a rod-shaped welding electrode in the collet, and/or
wherein the collet housing which surrounds the collet has a receiving contour such that the collet can be pushed in from the rear through the receiving contour of the collet housing.

3. The electrode clamping device as claimed in claim 1, wherein the collet has, on its front end portion at its front collet end, a plurality of clamping jaws which are arranged radially, are separated by slots widen radially and/or axially and are pressed together by means of an internal clamping and current contact surface of the surrounding collet housing on the front collet housing end in order to hold in a centered manner the rod-shaped welding electrode introduced into the collet, as soon as the collet is moved rearwards relative to the collet housing surrounding it.

4. The electrode clamping device as claimed in claim 1, wherein the collet is moved relative to the collet housing, which surrounds it, by means of a spring mechanism of the electrode clamping device.

5. The electrode clamping device as claimed in claim 1, wherein the clamping jaws of the collet have flat milled portions for optimising optimizing the clamping force.

6. The electrode clamping device as claimed in claim 1, wherein:
the clamping jaws which are provided on the front end portion of the collet and widen radially and/or axially have a specified first opening angle, α; and/or
the collet housing has, on a front end portion, a contact-pressing surface having a second opening angle, β.

7. The electrode clamping device as claimed in claim 5, wherein:
the first opening angle, α, of the collet is equal to or greater than the second opening angle, β, of the surrounding collet housing;
the first opening angle, α, is in an angle range of 20 to 90°; and
the second opening angle, β, is in an angle range of 0° to 90°.

8. The electrode clamping device as claimed in claim 4, wherein the collet which is arranged so as to be movable along the longitudinal axis of the rod-shaped welding electrode is connected to a pressure cap (84 which is provided on a rear side of the welding torch, can be manually actuated and surrounds the spring mechanism of the electrode clamping device.

9. The electrode clamping device as claimed in claim 1, wherein the collet housing has radial bores, through which a protective gas supplied to the welding torch is discharged into a gas nozzle surrounding the welding electrode.

10. The electrode clamping device as claimed in claim 1, wherein the contact-pressing surface provided on the front end portion of the collet housing has a radius which is in a range of 0 to 1 mm.

11. The electrode clamping device as claimed in claim 1, wherein:
the surface of the collet and/or of the collet housing is surrounded by a current-conducting oxidation protective layer for protecting against oxidation and for protecting against wear;
the current-conducting oxidation layer consists of silver or nickel or has a high-temperature sliding lacquer coating; and/or
the material of the collet consists of a copper alloy.

12. The electrode clamping device as claimed in claim 1, wherein auxiliary components, in particular a cold wire or hot wire supplying unit, can be mounted on a housing casing of the welding torch.

13. The electrode clamping device as claimed in claim 1, wherein a first current contact surface between the rod-shaped welding electrode and the collet and a second current contact surface between the collet and the collet housing are arranged axially offset with respect to one another.

14. The electrode clamping device as claimed in claim 3, wherein the slots of the collet have a slot length of 10 to 20 mm and/or the slots have a slot width in a range of 0.5 mm to 1 mm and/or at least 3 slots are provided.

15. Welding A welding torch, wherein the welding torch has a non-fusible, rod-shaped welding electrode with a tip, wherein the tip of the welding electrode is provided on a front side of the welding torch and wherein the welding torch has an electrode clamping device as claimed in claim 1 for mechanically clamping the non-fusible, rod-shaped welding electrode into the welding torch.

16. The electrode clamping device as claimed in claim 7, wherein:
the first opening angle, α, is in an angle range of 20 to 35°; and
the second opening angle, β, is in an angle range of 20° to 30°.

17. The electrode clamping device as claimed in claim 10, wherein the contact-pressing surface has a radius which of 0.1 mm.

18. The electrode clamping device as claimed in claim 14, wherein the have a slot length of 14 mm, and/or the slots have a slot width in a range of 0.6 mm to 0.8 mm and/or at least 4 slots are provided.
